(19) United States
(12) Patent Application Publication
(10) Pub. No.: US 2026/0268163 A1
(43) Pub. Date: Sep. 10, 2026

(54) COMPONENT-WISE MERGED VISION-LANGUAGE MODEL

(71) Applicant: SAMSUNG ELECTRONICS CO., LTD., Suwon-si (KR)

(72) Inventors: Wenxuan ZHANG, Thuwal (SA); Suren KUMAR, Seattle, WA (US); Luowei ZHOU, Bellevue, WA (US)

(73) Assignee: SAMSUNG ELECTRONICS CO., LTD., Suwon-si (KR)

(21) Appl. No.: 19/549,482

(22) Filed: Feb. 25, 2026

Related U.S. Application Data
(60) Provisional application No. 63/767,479, filed on Mar. 5, 2025.

(51) Int. Cl. G06N 3/0985

(52) U.S. Cl. CPC G06N 3/0985

(57) ABSTRACT

A computer-implemented method operated by an electronic device, for generating an improved vision-language model (VLM), includes: obtaining input VLMs including at least one pre-trained based model and a plurality of fined tuned models, wherein each of the at least one pre-trained based model and the plurality of fined tuned models comprises a plurality of components that correspond to a text encoder, a vision encoder, or a projection layer of the VLM; determining a first set of weights that correspond to the plurality of components; generating a first merged model by performing a component-wise merging that comprises: multiplying the plurality of components with the first set of weights; combining the multiplied plurality of components; determining a first performance of the first merged model by validating the first merged model based on an optimization objective.

### CROSS-REFERENCE TO RELATED APPLICATIONS

This application is based on and claims priority under 35 U.S.C. § 119 to U.S. Patent Provisional Application No. 63/767,479, filed on Mar. 5, 2025, in the United States Patent and Trademark Office, the disclosure of which is incorporated by reference herein in its entirety.

### BACKGROUND

### 1. Field

The present disclosure relates to a system and a method for generating an artificial intelligence (AI) model by merging weights of components in multiple input models including at least one pre-trained vision-language models (VLMs) and fine-tuned models. Embodiments or aspects of the present disclosure provide specific improvements to relevant technical fields, such as reducing graphic processing unit (GPU) and data costs.

### 2. Description of Related Art

There has been a widespread adoption of fine-tuning pre-trained VLMs to solve specific downstream tasks. Despite the effectiveness, model fine-tuning incurs significant costs including computation as well as in gathering annotation data and engineering effort. In response to these challenges, leveraging fine-tuned model parameters presents a viable alternative, mitigating privacy concerns, and bypasses the need for extensive retraining. Various operations such as ensemble, composition, mixture of experts, and token-space fusion have been developed under this paradigm. Of particular note is ‘model merging,’ an operation that combines parameters from multiple models, each with different capabilities, into a unified model. This approach maintains inference efficiency of a single model architecture while accumulating the knowledge from multiple models to handle diverse downstream tasks.

Recent advancements of model merging primarily span merge operations and optimization strategies for merging ‘weights’ in the language domain. Despite its success, applications of model merging to the vision-language domain remain underexplored, particularly in the context of modern large VLMs. Another bottleneck in widespread adoption of model merging is the need for hundreds of hours of GPU compute required for recent operations for model merging.

### SUMMARY

The present disclosure are directed to frameworks for VLMs based on modality-specific model merging and optimization operations that learn to combine merging candidates.

According to an aspect of the disclosure, a computer-implemented method, operated by an electronic device, for generating an improved vision-language model (VLM), including: obtaining input VLMs including at least one pre-trained based model and a plurality of fined tuned models, wherein each of the at least one pre-trained based model and the plurality of fined tuned models includes a plurality of components that correspond to a text encoder, a vision encoder, or a projection layer of the VLM; determining a first set of weights that correspond to the plurality of components; generating a first merged model by performing a component-wise merging that includes: multiplying the plurality of components with the first set of weights; combining the multiplied plurality of components; determining a first performance of the first merged model by validating the first merged model based on an optimization objective; determining a second set of weights that correspond to the plurality of components; generating a second merged model by performing the component-wise merging using the second set of weights; and determining a second performance of the first merged model by validating the second merged model, wherein, in a first case that the first performance exceeds the second performance, the first merged model is used by the electronic device for an application for VLM, and wherein, in a second case that the second performance exceeds the first performance, the second merged model is used by the electronic device for the application for VLM.

According to an aspect of the present disclosure, an electronic device includes: a memory; and a processor operatively connected to the memory; wherein the processor is configured to: obtain input VLMs including at least one pre-trained based model and a plurality of fined tuned models, wherein each of the at least one pre-trained based model and the plurality of fined tuned models includes a plurality of components that correspond to a text encoder, a vision encoder, or a projection layer of the VLM; determine a first set of weights that correspond to the plurality of components; generate a first merged model by performing a component-wise merging that includes: multiplying the plurality of components with the first set of weights; combining the multiplied plurality of components; determine a first performance of the first merged model by validating the first merged model based on an optimization objective; determine a second set of weights that correspond to the plurality of components; generate a second merged model by performing the component-wise merging using the second set of weights; and determine a second performance of the first merged model by validating the second merged model, wherein, in a first case that the first performance exceeds the second performance, the first merged model is used by the electronic device for an application for VLM, and wherein, in a second case that the second performance exceeds the first performance, the second merged model is used by the electronic device for the application for VLM.

According to an aspect of the present disclosure, a computer-implemented method, operated by a first electronic device connected with a second electronic device, for generating an improved vision-language model (VLM), includes: obtaining input VLMs including at least one pre-trained based model and a plurality of fined tuned models, wherein each of the at least one pre-trained based model and the plurality of fined tuned models includes a plurality of components that correspond to a text encoder, a vision encoder, or a projection layer of the VLM; determining a first set of weights that correspond to the plurality of components; generating a first merged model by performing a component-wise merging that includes: multiplying the plurality of components with the first set of weights; combining the multiplied plurality of components; determining a first performance of the first merged model by validating the first merged model based on an optimization objective; determining a second set of weights that correspond to the plurality of components; generating a second merged model by performing the component-wise merging using the second set of weights; and determining a second performance of the first merged model by validating the second merged model, wherein, in a first case that the first performance exceeds the second performance, the first electronic device transmits the first merged model to the second electronic device, and wherein, in a second case that the second performance exceeds the first performance, the first electronic device transmits the second merged model to the second electronic device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates example components of an electronic device in accordance with embodiments of the disclosure;

FIG. 2 illustrates an example framework of the present disclosure;

FIG. 3 illustrates an example of model merging operations;

FIG. 4 illustrates example operations of the present disclosure;

FIG. 5 illustrates example operations of the present disclosure; and

FIG. 6 illustrates example operations of the present disclosure.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms may not be interpreted as ideally or excessively formal meanings. Even though a term is defined in the disclosure, the term may not be interpreted as excluding embodiments of the disclosure under circumstances.

The present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., through at least one wire), wirelessly, or via a third element.

In the present disclosure, “parameters” may refer to model weights, and “weights” may refer to hyperparameters in model merging. “Merging weights” may also be referred to as “scaling weights.”

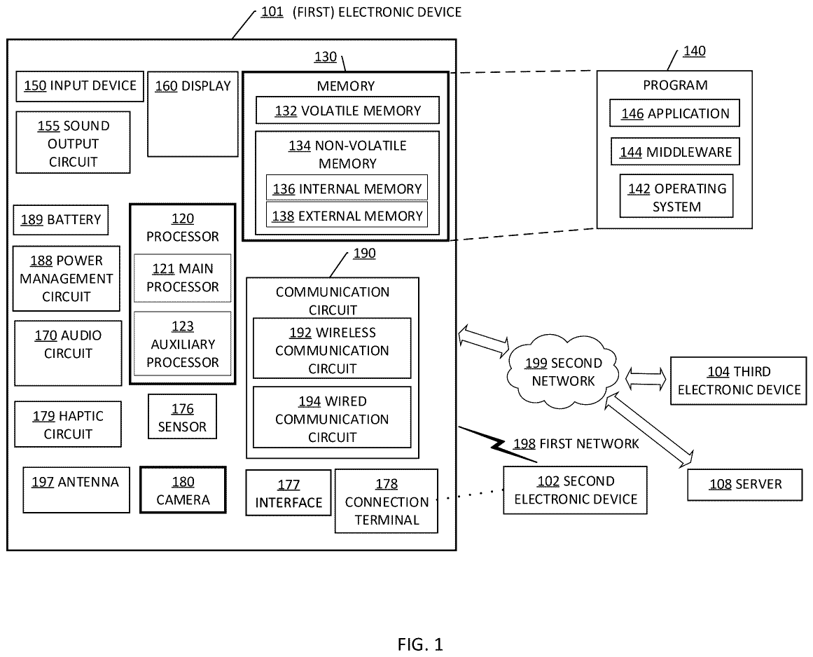

FIG. 1 illustrates example components of the electronic device in accordance with some embodiments of the disclosure. In an embodiment, the at least one processor 120 may be implemented in hardware, firmware, or a combination of hardware and software. The at least one processor 120 may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The at least one processor 120 are able to perform control of any one or any combination of the other components of the computing device, and/or perform an operation or data processing relating to communication. The at least one processor 120 execute one or more programs stored in a memory.

The at least one processor 120 may be implemented as one or more multi-core processors that include one or more cores (e.g., homogeneous multi-cores or heterogeneous multi-cores). When a plurality of cores are included in the at least one processor 120, each of the cores includes a cache memory, and a common cache shared by the cores may be included in the at least one processor 120. Each of the cores may independently read and execute program instructions or each of the cores may read and execute one or more portions of program instructions.

In some embodiments, the at least one processor 120 may refer to a system-on-a-chip (SoC) in which one or more cores and other electronic components are integrated, a single core processor, a multicore processor, or a core included in the single core processor or the multicore processor, wherein the core may be implemented as a CPU, a GPU, an APU, an MIC, an FPGA, a DSP, an NPU, a hardware accelerator, or a machine learning accelerator, but the embodiments of the disclosure are not limited thereto.

In an embodiment, the memory 130 may include a random access memory (RAM), a read only memory (ROM), and/or another type of dynamic or static storage device (e.g., a flash memory, a magnetic memory, and/or an optical memory) that stores information and/or instructions for use by the processor 120. In an embodiment, the memory 130 may contain information and/or software related to the operation and use of the electronic device 100. For example, the memory 130 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, or another type of non-transitory computer-readable medium, along with a corresponding drive.

In an embodiment, the communication circuit 110 may include a transceiver-like component (e.g., a transceiver and/or a separate receiver and transmitter) that enables the electronic device 100 to communicate with other devices, such as via a wired connection, a wireless connection, or a combination of wired and wireless connections. The communication circuit 110 may permit the electronic device 100 to receive information from another device and/or provide information to another device. For example, the communication circuit 110 may include an Ethernet interface, an optical interface, a coaxial interface, an infrared interface, a radio frequency (RF) interface, a universal serial bus (USB) interface, a Wi-Fi interface, a cellular network interface, or the like. In an embodiment, the communication circuit 110 may be a communication ‘interface’ used to connect the electronic device 100 with the other devices.

Additionally or alternatively, a set of components (e.g., one or more components) of the electronic device 100 may perform one or more functions described as being performed by another set of components of the electronic device 100.

The present disclosure describes a unified view of model merging and applications of the model merging to the domain of VLMs. A model merging method (for example, a low-budget model merging method) for VLMs may be achieved by applying, for example, Bayesian optimization to component-specific merging weights.

The present disclosure is directed to a unified framework that formulates model merging as a budget-based problem, characterized by diverse merging operations and optimization strategies. This framework helps to identify critical components that significantly affect performance and also facilitate transferring the design principles across different models. Within this framework, the present disclosure introduces Bayesian optimization, as an example of operations well-suited to the above problems.

Some embodiments of the present disclosure may include the following operations: the utility of treating the base model alongside the task-specific models as a merge candidate; optimizing the scaling weights for different components (e.g., vision encoder vs. projection layer), a particular design for VLMs; leveraging Bayesian optimization to optimize the scaling weights; and low-budget/compute consumption.

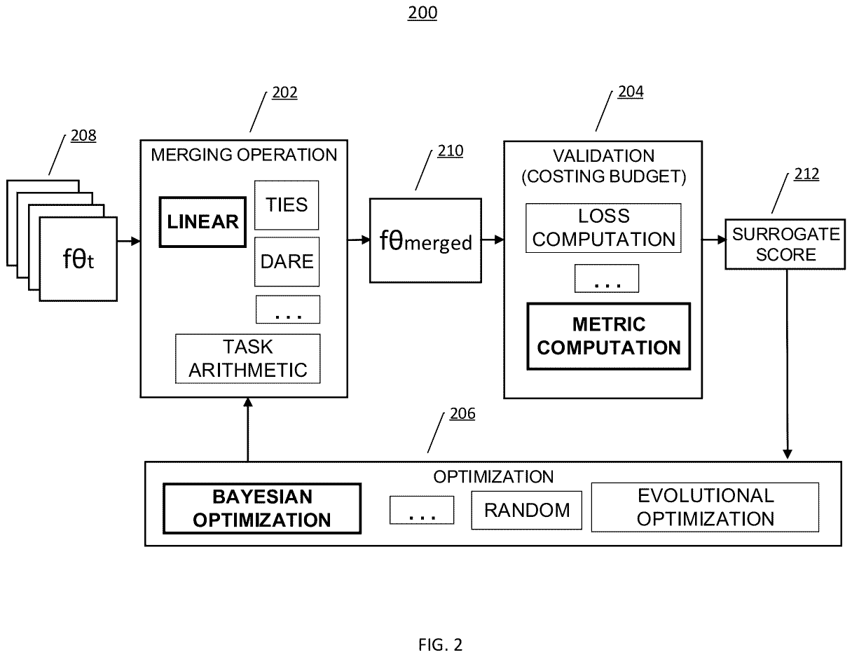

FIG. 2 illustrates an example framework 200 of the present disclosure. As shown in FIG. 2, the example framework 200 includes a merging operation 202, a validation operation 204, and an optimization operation 206.

The merging operation 202 includes at least one of a linear operation, Ties operation, DARE, or Task Arithmetic. The merging operation may be used to merge multiple input data 208.

The validation operation 204 may validate the outcome of the merging operation 202, which is f θ_{merged} 210.

The output of the validation operation 204 is a surrogate score 212. In the development and evaluation of complex machine learning architectures, the surrogate score serves as a critical proxy for objective functions that are otherwise computationally prohibitive or mathematically intractable. For example, by mapping the outputs of a high-dimensional ‘black-box’ model onto a simpler, differentiable manifold, researchers can utilize surrogate loss functions to facilitate, for example, gradient-based optimization where discrete metrics fail to provide useful derivatives.

The optimization operation 206 receives the surrogate score 212. The optimization operation 206 may include at least one of: random, evolutional optimization, or Bayesian optimization. Based on the surrogate score 212, the optimization operation 206 is performed to optimize the merging operation 202.

A unified view on model merging is described below.

Despite the increasing popularity of model merging, a significant gap remains in exploring its application to modern VLMs. To address this gap and provide a more comprehensive understanding of model merging across multiple modalities, a unified framework that enables the systematic integration is discussed herein.

In an embodiment, model merging may be defined as follows. Given a set of N fine-tuned models

$${\{ {θ}_{n} \}}_{n = 1}^{N}$$

(referred to as merge candidates) and a merging operation M (that may correspond to the merging operation 202), the goal of the embodiment is to derive a single model θ_{merged} that maximizes the performance function ƒ on the validation set.

In the related art, existing merging algorithms mainly fall into two categories. Some methods exhaustively search through weight combinations, selecting the best-performing merged model based on validation results. These methods are referred to as ‘static merging.’ In contrast, other methods incorporate more complex optimization strategies to iteratively refine merging weights based on past performance. These methods are referred to as ‘dynamic merging.’

In an embodiment of the present disclosure, to simplify the problem and focus on core merging elements, scenarios in which all fine-tuned models share the same architecture are considered. In other embodiments, the fine-tuned models may have different architectures.

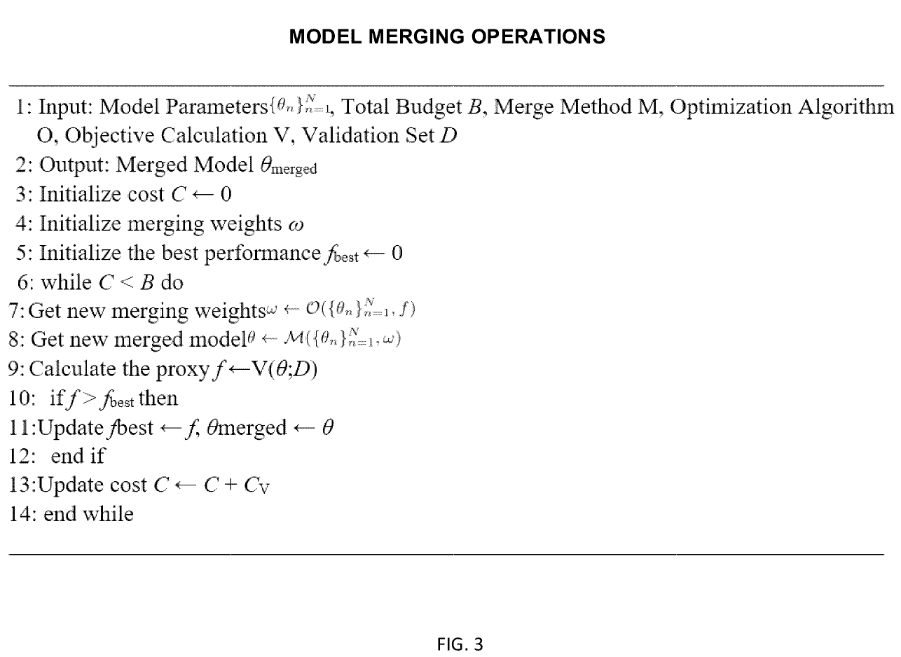

A unified framework may integrate overall compute budget, merge operation, optimization operation, and optimization objective, thus may offer a structured view to model merging, for example, as outlined in the operation set of FIG. 3.

In FIG. 3, under a fixed budget C (line 6, 13), the current merging weights are refined using the optimization algorithm O (line 7), followed by the execution of the merging operation M (line 8). The resulting merged model undergoes validation V, incurring a computational cost CV, to assess its performance for subsequent optimization rounds (line 9-11).

That is, to extend the model merging to VLMs, the following elements may be considered for VLM merging: a budget, merging operations, weight optimization, and optimization objective.

First, the budget is described. Existing methods assume an abundance of computational resources for optimizing merging weights. However, the actual computation may become prohibitively expensive as the number of optimization rounds r and merging candidates N increase. Given that model merging is primarily aimed at reducing graphic processing unit (GPU) and data costs, budget constraints are defined in terms of available GPU computation in a low-data setting (i.e., a small validation set). One budget unit is one validation/optimization round. In one embodiment, as an example, the budget is set to eight (8), suggesting a low-budget regime. In other embodiments, the budget may be set to a different value. Thus, the embodiments of the present disclosure provide improvements to the existing technologies by considering the restrained budgets and reducing graphic processing unit (GPU) and data costs.

Second, the merging operations are described. Merging operations typically involve scaling and pruning. ‘Static merging’ approaches leverage consensus and sparsification methods to prune parameters, while ‘dynamic merging’ techniques focus on learning optimal scaling factors, often neglecting pruning strategies. In some embodiments, scaling (i.e., Linear and Task Arithmetic) may yield better models compared to the pruning-based methods, hence the merging operation may only use scaling weights.

Third, the weight optimization is described. Recent studies have highlighted the importance of weight optimization in model merging. These approaches utilize optimization methods. However, many of these studies lack explicit discussions on the selection of optimization method, leaving open questions regarding the best strategies. As a non-limiting example, as a weight optimization operation, the present disclosure proposes using Bayesian optimization operation, which may lead to better learning outcomes while maintaining generalization capabilities. However, the present disclosure is not limited to Bayesian optimization operation. In other embodiments, other optimization operations, such as Kriging (Gaussian Processes), Tree-based Parzen Estimator (TPE), Hyperband/Successive Halving, and Random Search.

Fourth, the optimization objective is described. ‘Validation proxy’ often serves as the objective function for merging weight optimization. There are two primary validation proxies used in model merging: task loss and task-specific performance metrics (e.g., accuracy). However, different proxies exhibit varying reliability across architectures. For instance, in autoregressive models, task-specific metric computation (e.g., visual question answering (VQA) accuracy) is more computationally expensive than loss computation, but its computation is closer to that of final evaluation. Thus, choosing an appropriate validation proxy has a profound impact on computational efficiency and the number of feasible optimization rounds under a fixed budget. While smaller models may maintain consistent performance across various optimization strategies, larger models may require careful consideration of metric-based validation proxies to effectively support the optimization process.

Embodiments of integrating model merging to VLMs are described below.

The framework or its method of the present disclosure is built from two perspectives: what merging weights to optimize and how to optimize the merging weights.

Component-wise linear merging is explained herein. As mentioned earlier, allocating the budget to optimize the weights of scaling the merging candidates rather than pruning may yield better performance. In general, it is crucial for efficiency to tune as few merging weights as possible. Based on these principles, the ‘linear merging’ may be used as the base merge operation.

Furthermore, ‘Task Arithmetic merging’ has shown strong performance in both learning and generalization. Specifically, for a pre-trained base model θₚ and fine-tuned models

$${\{ {θ}_{n} \}}_{n = 1}^{N} ,$$

Task Arithmetic merging is defined as θ=θₚ+λΣₙ(θₙ−θₚ), which is equivalent to θ=(1−Nλ)θₚ+λΣₙθₙ. Here λ is the merging weight. This formulation is equivalent to extending linear merge with the base model as an additional merge candidate. Consequently, the linear merging is applied to the candidate set

$$\{ {θ}_{p} \} ⋃ {\{ {θ}_{n} \}}_{n = 1}^{N}$$

while optimizing the merging weights.

Component-wise linear merge is proposed in the present disclosure, where separate merging weights are optimized for each model component. Specifically, the merging operation for module m is

$${θ}_{merged}^{m} = {\sum }_{n = 1}^{N} {w}_{n}^{m} {θ}_{t}^{m} + {w}_{p}^{m} {θ}_{p}^{m} ; \qquad ( EQN . 1 )$$

Where

$${θ}_{t}^{m}$$

represents the parameters in module m of the model

$${θ}_{t} , {w}_{t}^{m}$$

is the merging weight for module m in model θₜ, and wₚ^{m} is the merging weight for module m in the pre-trained model.

Under this formulation, for one example of ‘Contrastive Language-Image Pretraining’ (CLIP), separate weights are introduced for both of the vision tower and the text tower. For another example of ‘Large Language and Vision Assistant’ (Llava), separate weights are introduced for multi-modal projection and a text encoder, while using the frozen vision encoder. Therefore, in the example of Llava, the number of merging weights to optimize is only 2(N+1) for N candidates. All weights are constrained to [0, 1], and unlike pruning-based merging of the related art, the weights do not have strong dependencies. This may significantly reduce optimization complexity.

Optimizing weights with Bayesian optimization is described. Gradient-free optimization methods offer greater flexibility in learning merging weights compared to random or exhaustive search. The optimization methods are designed from two perspectives: the optimization algorithm and the optimization objective.

Commonly used objectives in model merging include loss-based and metric-based validation performance. For example, in a case of the metric-based validation performance, given a set of T validation sets

$${\{ {D}_{i} \}}_{i = 1}^{T}$$

of the target tasks, and metric calculation functions

$${\{ {V}_{i} \}}_{i = 1}^{T}$$

of each validation set, the optimization objective is defined as

$$f = {\sum }_{i = 1}^{T} {V}_{i} ( θ ; {D}_{i} ) . \qquad ( EQN . 2 )$$

From the optimization algorithm perspective, Bayesian optimization may achieve superior performance in some cases. Bayesian optimization may construct a probabilistic model of the objective function, enabling efficient global optimization by selecting the informative points for evaluation. Bayesian optimization may operate effectively in low-dimensional settings. These properties align well with component-wise linear merging strategy. Therefore, Bayesian optimization may be used to optimize the merging weights

$$\{ {w}_{n}^{m} \} , {w}_{p}^{m}$$

[Start of Description about Bayesian Optimization]

Bayesian optimization may be best suited for the optimization problem where the objective is noisy, expensive to evaluate, and the feasible set is continuous and less than 20 dimensions. Bayesian optimization may include two main components, a Bayesian statistical model to represent the objective function, and an acquisition function that decides where to sample next.

For a single-objective optimization problem

$${max}_{x ∈ A} f ( x ) ,$$

where ƒ: [symbol] ⁿ→ [symbol] is a real valued objective function and n is the dimension of the feasible set. BO starts by sampling initial ‘design of experiments (DoE)’ {x₁, . . . , xₖ}⊆A. Leveraging the initial DoE and its corresponding objective values {ƒ(x₁), . . . , ƒ(xₖ)}⊆ [symbol] , Bayesian optimization may construct a statistical model, which is a Gaussian process, for the distribution of [ƒ(x₁), . . . , ƒ(xₖ)]=:ƒ(x_{1:}) as

$$f ( {x}_{1 : k} ) ∼ Norma1 ( {μ}_{0} ( {x}_{1 : k} ) , {\sum }_{0} ( {x}_{1 : k} , {x}_{1 : k} ) ) , \qquad ( EQN . 3 )$$

where μ₀(x_{1:k}) and Σ₀(x_{1:k},x_{1:k}) are the compact notation for their corresponding high dimension variable [μ₀(x₁), . . . , μ₀(xₖ)] and Σ₀(x₁, x₁), . . . , Σ₀(x₁, xₖ) . . . , Σ₀(xₖ, x₁), . . . , Σ₀(xₖ, xₖ). μ₀ is a mean function and chosen to be constant μ₀(x)=x. Σ₀ is the covariance function and Gaussian kernel is commonly used to as it, i.e., Σ₀(x,x′)=α₀ exp(−∥x−x′∥²). Given such prior distribution, one may compute a Bayesian posterior probability distribution that describes potential values for ƒ(x) at the next candidate point x as

$$f ( x ) \vert f ( {x}_{1 : k} ) ∼ Norma1 ( {μ}_{k} ( x ) , {σ}_{k}^{2} ( x ) ) , where \qquad ( EQN . 4 )$$

$${μ}_{k} ( x ) = {\sum }_{0} ( x , {x}_{1 : k} ) {\sum }_{0} {( {x}_{1 : k} , {x}_{1 : k} )}^{- 1} ( f ( {x}_{1 : k} ) - {μ}_{0} ( {x}_{1 : k} ) ) + {μ}_{0} ( x ) ,$$

$${σ}_{k}^{2} ( x ) = {\sum }_{0} ( x , x ) - {\sum }_{0} ( x , {x}_{1 : k} ) {\sum }_{0} {( {x}_{1 : k} , {x}_{1 : k} )}^{- 1} {\sum }_{0} ( {x}_{1 : k} , x ) .$$

Then, an acquisition function is computed using the current posterior distribution, and the next x is chosen as the arg-maximum of the acquisition function. The commonly used acquisition function may be the expected improvement. When

$${f}_{k}^{*} = {max}_{m \leq k} f ( {x}_{m} )$$

is the largest observed value, the goal of acquisition function is to maximize the expected improvement of the best observed objective,

$${EI}_{k} ( x ) := 𝔼 [ {[ f ( x ) - {f}_{k}^{*} ]}^{+} \vert f ( {x}_{1 : k} ) ] , \qquad ( EQN . 5 )$$

where [a]⁺=max(a, 0) is the positive part of the value. The expected improvement may be evaluated in closed form using integration by parts, and the resulting expression is

$${EI}_{k} ( x ) = {[ {Δ}_{k} ( x ) ]}^{+} + {σ}_{k} ( x ) φ ( \frac{{Δ}_{k} ( x )}{{σ}_{k} ( x )} ) - \vert {Δ}_{k} ( x ) \vert Φ ( \frac{{Δ}_{k} ( x )}{{σ}_{k} ( x )} ) , \qquad ( EQN . 6 )$$

where

$${Δ}_{k} ( x ) = {μ}_{k} ( x ) - {f}_{k}^{*}$$

is the expected difference in quality between the proposed point x and the previous best, φ and Φ are the standard normal density and distribution function, and σₖ(x) is the standard error of the DACE predictor.
[End of Description about Bayesian Optimization]

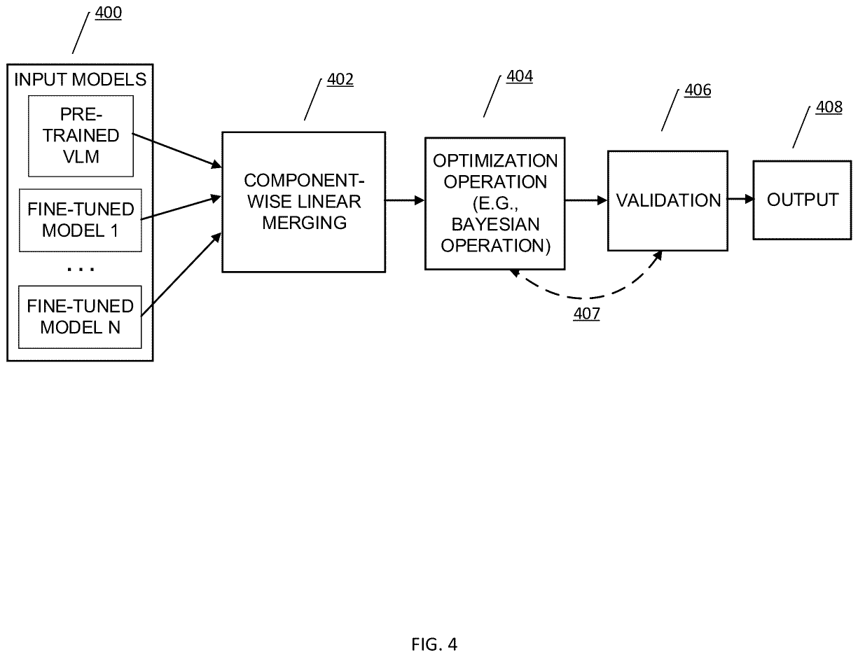

FIG. 4 illustrates example operations of the present disclosure.

In operation 400, the input models may include a pre-trained VLM θp, a fine-tuned model 1 θ₁, . . . , and a fine-tuned model N θ_{N}.

In operation 402, a component-wise linear merging is performed, for example, by the above EQN. 1,

$${θ}_{merged}^{m} = {\sum }_{n = 1}^{N} {w}_{n}^{m} {θ}_{t}^{m} + {w}_{p}^{m} {θ}_{p}^{m} ;$$

where

$${θ}_{t}^{m}$$

represents the parameters in module m of the model θₜ, wₗ^{m} is the merging weight for module m in model θₜ, and wₚ^{m} is the merging weight for module m in the pre-trained model. That is, the (initial) merged VLM is produced by the following operations: 1) multiplying the parameters of the at least one pre-trained VLM with corresponding merging weights and multiplying the parameters of the at least one fine-tuned VLM with corresponding merging weights, and 2) merging the multiplied parameters in a component-wise manner.

In operation 404, an optimization operation (e.g., Bayesian operation) may be performed. For example,

$${w}_{n}^{m}$$

(the merging weight for module m in model θₜ) and wₚ^{m} (the merging weight for module m in the pre-trained model) may be optimized (or updated) by Bayesian operation that is described above.

In operation 406, an validation operation may be performed. For example, as stated above, in a case of the metric-based validation performance, given T validation sets

$${\{ {D}_{i} \}}_{i = 1}^{T}$$

of the target tasks, and metric calculation function

$${\{ {V}_{i} \}}_{i = 1}^{T}$$

of each validation set, the optimization objective is defined as

$$f = {\sum }_{i = 1}^{T} {V}_{i} ( θ ; {D}_{i} ) . \qquad ( EQN . 2 )$$

In an embodiment, as shown in an arrow 407, operation 406 may be performed before operation 404 is performed. That is, operation 406 may be performed after operation 402 is performed and before operation 404 is performed.

In operation 408, given a set of N fine-tuned models

$${\{ {θ}_{n} \}}_{n = 1}^{N} ,$$

(that are merge candidates shown in operation 400), and the merging operation M (shown in operation 402), a single model θ_{merged} is obtained, which maximizes the performance function ƒ on the validation sets

$${\{ {D}_{i} \}}_{i = 1}^{T}$$

(shown in operation 406).

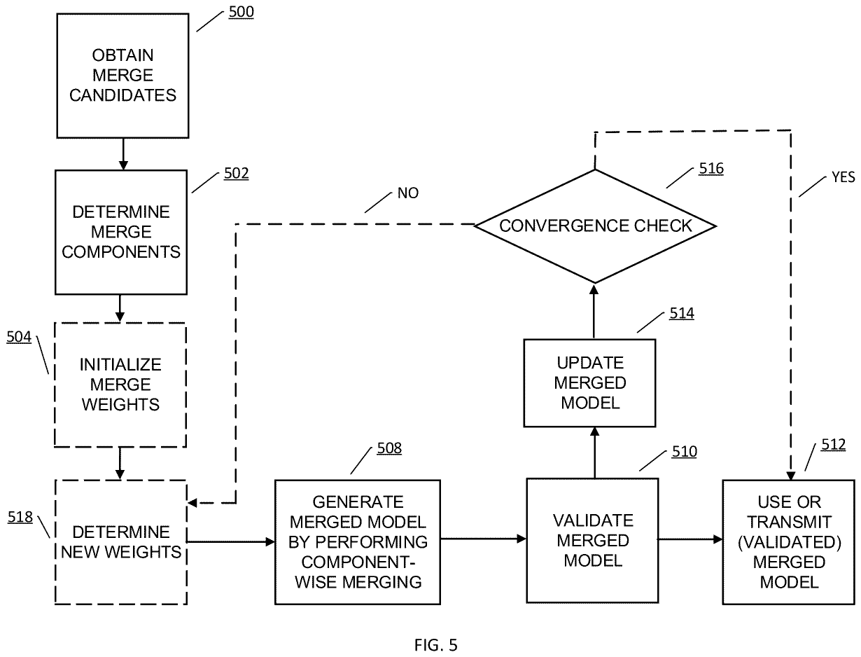

FIG. 5 illustrates example operations of the present disclosure. The dashed lines indicate that the corresponding operations are optional.

In operation 500, merge candidates are obtained. Examples of the merge candidates are a combination of a pre-trained base model VLM θₚ (e.g., CLIP) and N fine-tuned VLMs {θₙ}^{N}ₙ₌₁. The combination (candidate set) may be {θₚ}∪{θₙ}^{N}ₙ₌₁. CLIP is an example of the pre-trained base model. The present disclosure is not limited to CLIP.

In operation 502, merge components are determined or defined. For example, the VLMs are divided or partitioned into m components, for example, a vision encoder, a text encoder, or projection layers (if applicable). Those m components may include or may correspond to merge weights, respectively. Operation 500 and 502 may correspond to operation 400 of FIG. 4.

In operation 504, optionally, the merge weights may be initialized. For example, for each merge component m and the model i, their weight

$${w}_{i}^{m} ( ∈ [ 0 , 1 ] )$$

may be initialized. For example, a number of total weights for CLIP may be 2(N+1) that is significantly lower than that of weights for other technologies in the related art. Operation 504 may correspond to line 4 in FIG. 3.

In operation 508, a merging of respective weights (in other words, component-wise merging) is performed to generate a merged model. In an embodiment, the merged model is

$${θ}_{merged}^{m} = {\sum }_{i}^{N} {w}_{i}^{m} {θ}_{i}^{m}$$

where i∈{p, 1, 2, . . . , N};

$${θ}_{i}^{m}$$

are parameters for component m in model i;

$${w}_{i}^{m}$$

are merge weights for the component m in model i. Operation 508 may correspond to operation 402 of FIG. 4 and may correspond to line 2 of FIG. 3.

In operation 510, the merged model may be validated. In a case of metric-based validation, as stated above, given a set of T validation sets

$${\{ {D}_{i} \}}_{i = 1}^{T}$$

of the target tasks, and metric calculation functions

$${\{ {V}_{i} \}}_{i = 1}^{T}$$

of each validation set, the optimization objective may be defined as

$$f = {\sum }_{i = 1}^{T} {V}_{i} ( θ ; {D}_{i} ) \qquad ( EQN . 2 )$$

and thus, the merged model may be validated based on the defined optimization objective that includes a plurality of calculation functions for a plurality of validation sets about a plurality of target tasks. Also, the metric-based validation is an example of a validation operation or method. In an embodiment, loss-based validation may be used, instead of the metric-based validation. For some complex architectures, the metric-based validation may perform better than the loss-based validation.

In operation 512, the validated merged model is used at the electronic device or is transmitted to another electronic device located in another place. For example, the first electronic device 101 of FIG. 1 may utilize the validated merge model or may transmit the validated merged model to another electronic device such as the server 108 via the second network 199.

In operation 514, optionally, the optimization objective (ƒ) for the particular components and weights (e.g., initial components and weights determined in operation 502) may be compared with an optimization objective related to ‘best’ performances, for example, in terms of reducing graphic processing unit (GPU) and data costs. When the optimization objective (ƒ) is better than the optimization objective (ƒbest), that is, ƒ>ƒbest, then the weights of the optimization objective (ƒ) may be considered to be used in the (final) merged model, based on a determination at operation 516.

For example, based on EQN. 2, the optimization objective (ƒ) is determined by T (the number of target tasks), Dᵢ (validation sets for each target task; for example, one hundred (100) examples per task, five hundreds (500) total), Vᵢ is the actual task-specific metric calculation functions (e.g., classification accuracy, VQA accuracy). When given a merged model θ, ƒbest is determined through:
1. Initialization: ƒbest=0 at the start of optimization;
2. Update the rule: After each optimization round, if the current objective ƒ exceeds ƒbest, then ƒbest is updated to ƒ (the corresponding merged model θ is saved as θmerged and merging weights are saved as well).

In operation 516, a convergence check is performed: whether the optimization operation (e.g., Bayesian optimization) has converged. If ‘YES’, the weights at operation 514 are used in the (final) merged model. If ‘NO’, the weights are used at operation 518, and later, at operation 508, those weights are used for component-wise merging.

The present disclosure adopts a budget-based termination for efficiency: for example, eight (8) budget units for all experiments, each budget unit is a validation/optimization round. Once the iteration reaches the preset budget limit (8 rounds), the iteration stops. Overall for Bayesian optimization, an improvement-based convergence may be used: if ƒbest has not improved for K consecutive iterations, it is deemed as converged, where K is a patience hyperparameter (typically 5-20 iterations).

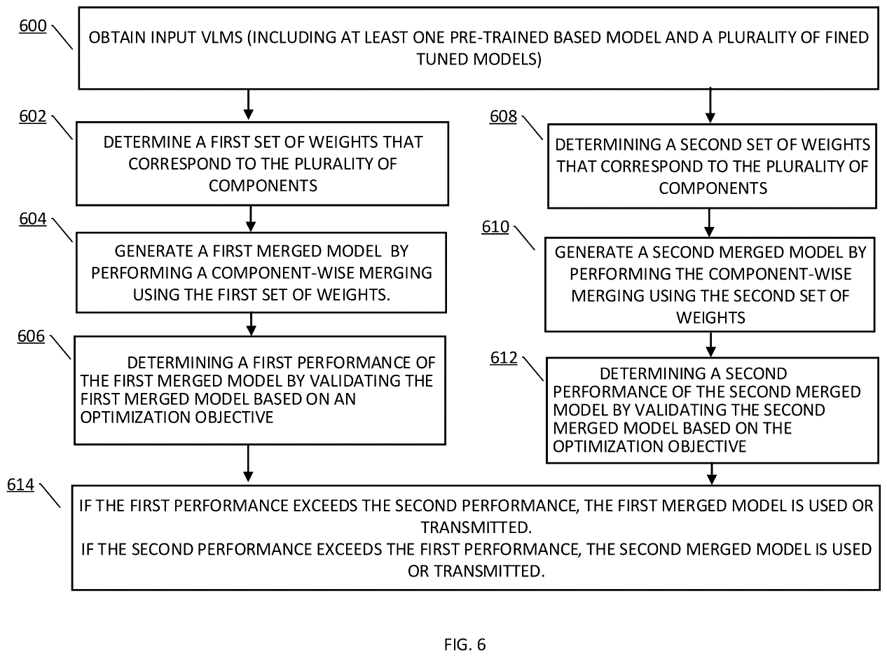

FIG. 6 illustrates example operations of the present disclosure, which may be performed by an electronic device such as a server in a cloud system (e.g., the server 108) or a terminal (e.g., the first electronic device 101, the second electronic device 102, or the third electronic device 104).

In operation 600, input VLMs are obtained. The input VLMs include at least one pre-trained based model and a plurality of fined tuned models. Each of the at least one pre-trained based model and the plurality of fined tuned models may include a plurality of components that correspond to a text encoder, a vision encoder, or a projection layer of the VLM.

In operation 602, a first set of weights, which correspond to the plurality of components, are determined. Operation 602 may correspond to operation 502 of FIG. 5.

In operation 604, a first merged model is generated by performing a component-wise merging. The component-wise merging may include: multiplying the plurality of components with the first set of weights; combining the multiplied plurality of components. Operation 604 may correspond to operation 508 of FIG. 5.

In operation 606, a first performance of the first merged model is determined by validating the first merged model based on an optimization objective.

In operation 608, a second set of weights, which correspond to the plurality of components, are determined.

In operation 610, a second merged model is generated by performing the component-wise merging using the second set of weights.

In operation 612, a second performance of the second merged model is determined by validating the second merged model based on the optimization objective.

In operation 614, in a first case that the first performance exceeds the second performance, the first merged model is used by the electronic device for an application for VLM. Alternative, the electronic device transmits the first merged model to another electronic device located in a remote place. In a second case that the second performance exceeds the first performance, the second merged model is used by the electronic device for the application for VLM. Alternative, the electronic device transmits the second merged model to another electronic device located in a remote place.

Practical applications of the embodiments in the present disclosure are described herein. For example, the final merged model, which is obtained at operation 408 or operation 512, is used by an electronic device (e.g., the first electronic device 101, the server 108) as an improved VLM utilized for generally known purposes, such as robotics and embodied AI (zero-shot task execution, industrial automation, autonomous vehicles), healthcare and medical imaging (automated report generation, VQA, pathology & dermatology), accessibility and inclusion (scene narration, dynamic alt-text, infographic translation), retail and e-commerce (visual search, automated cataloging, virtual try-ons), and enterprise and security (intelligent surveillance, document understanding, content moderation). For example, the electronic device (e.g., the first electronic device 101) may transmit the final merged model (e.g., the improved VLM) to the other electronic device (for example, the second electronic device 102, the third electronic device 104, or the server 108), and thus, the other electronic device may use the final merged model locally for at least one of the above generally known purposes.

The embodiments of the present disclosure may provide improvements to the computer systems or technology fields. By adopting the operations described above and shown in FIGS. 2-6, the embodiments of the present disclosure introduce optimization operations (e.g., Bayesian optimization) as a lightweight, non-gradient-based optimization method for learning model merging weights, which constructed a probabilistic surrogate model to efficiently identify optimal weight configurations with fewer evaluations compared to other methods in the related art, which rely on particle swarm optimization, evolutionary strategies, or manual search.

The operations of the present disclosure (for example, described above and shown in FIGS. 2-6) introduce modality-specific linear merging for VLMs, where separate merging weights are optimized for distinct model components (e.g., the vision encoder, the text encoder, the multi-modal projection layer), recognizing that different modalities contributes differently to downstream task performance—an insight not addressed by prior uniform-weight merging approaches that treat all parameters identically. Together, these contributions enable more effective knowledge composition across heterogeneous model components while achieving superior in-domain and out-of-domain accuracy over existing baselines.

One or more embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

According to one or more embodiments, in a non-volatile storage medium storing instructions, the instructions may be configured to, when executed by at least one processor, cause the at least one processor to perform at least one operation. The at least one operation may include displaying an application screen of a running application on a display, identifying a data input field included in the application screen, identifying a data type corresponding to the data input field, displaying at least one external electronic device, around the electronic device, capable of providing data corresponding to the identified data type, receiving data corresponding to the identified data type from an external electronic device selected from among the at least one external electronic device through a communication circuit, and entering the received data into the data input field.

The embodiments of the disclosure described in the present specification and the drawings are only presented as specific examples to easily explain the technical content according to the embodiments of the disclosure and help understanding of the embodiments of the disclosure, not intended to limit the scope of the embodiments of the disclosure. Therefore, the scope of one or more embodiments of the disclosure may be construed as encompassing all changes or modifications derived from the technical spirit of one or more embodiments of the disclosure in addition to the embodiments disclosed herein.

What is claimed is:

1. A computer-implemented method, operated by an electronic device, for generating an improved vision-language model (VLM), the computer-implemented method comprising:
obtaining input VLMs comprising at least one pre-trained based model and a plurality of fined tuned models, wherein each of the at least one pre-trained based model and the plurality of fined tuned models comprises a plurality of components that correspond to a text encoder, a vision encoder, or a projection layer of the VLM;
determining a first set of weights that correspond to the plurality of components;
generating a first merged model by performing a component-wise merging that comprises:
multiplying the plurality of components with the first set of weights; and
combining the multiplied plurality of components;
determining a first performance of the first merged model by validating the first merged model based on an optimization objective;
determining a second set of weights that correspond to the plurality of components;
generating a second merged model by performing the component-wise merging using the second set of weights; and
determining a second performance of the second merged model by validating the second merged model based on the optimization objective,
wherein, in a first case that the first performance exceeds the second performance, the first merged model is used by the electronic device for an application for VLM, and
wherein, in a second case that the second performance exceeds the first performance, the second merged model is used by the electronic device for the application for VLM.

2. The computer-implemented method of claim 1, wherein the optimization objective is determined based on a number of target tasks, a plurality of validation sets for each target set, and task-specific metric calculation functions.

3. The computer-implemented method of claim 2, further comprising:
determining additional sets of weights that correspond to the plurality of components; and
generating additional merged models based on an optimization operation with respect to the optimization objective, until performances of the additional merged models are converged to a target value.

4. The computer-implemented method of claim 3, wherein the optimization operation is Bayesian optimization.

5. The computer-implemented method of claim 1, wherein the first set of weights are initialized before the component-wise merging is performed.

6. The computer-implemented method of claim 1, each of the first performance and the second performance relates to at least one constraint of data costs of a graphic processing unit (GPU) or a budget to operate the improved VLM.

7. An electronic device comprising:
a memory; and
a processor operatively connected to the memory;
wherein the processor is configured to:
obtain input VLMs comprising at least one pre-trained based model and a plurality of fined tuned models, wherein each of the at least one pre-trained based model and the plurality of fined tuned models comprises a plurality of components that correspond to a text encoder, a vision encoder, or a projection layer of the VLM;
determine a first set of weights that correspond to the plurality of components;
generate a first merged model by performing a component-wise merging that comprises:
multiplying the plurality of components with the first set of weights; and
combining the multiplied plurality of components;
determine a first performance of the first merged model by validating the first merged model based on an optimization objective;
determine a second set of weights that correspond to the plurality of components;
generate a second merged model by performing the component-wise merging using the second set of weights; and
determine a second performance of the second merged model by validating the second merged model based on the optimization objective,
wherein, in a first case that the first performance exceeds the second performance, the first merged model is used by the electronic device for an application for VLM, and
wherein, in a second case that the second performance exceeds the first performance, the second merged model is used by the electronic device for the application for VLM.

8. The electronic device of claim 7, wherein the optimization objective is determined based on a number of target tasks, a plurality of validation sets for each target set, and task-specific metric calculation functions.

9. The electronic device of claim 8, wherein the processor is further configured to:
determine additional sets of weights that correspond to the plurality of components; and
generate additional merged models based on an optimization operation with respect to the optimization objective, until performances of the additional merged models are converged to a target value.

10. The electronic device of claim 9, wherein the optimization operation is Bayesian optimization.

11. The electronic device of claim 7, wherein the first set of weights are initialized before the component-wise merging is performed.

12. The electronic device of claim 7, wherein each of the first performance and the second performance relates to at least one constraint of data costs of a graphic processing unit (GPU) or a budget to operate the improved VLM.

13. A computer-implemented method, operated by a first electronic device connected with a second electronic device, for generating an improved vision-language model (VLM), the computer-implemented method comprising:
obtaining input VLMs comprising at least one pre-trained based model and a plurality of fined tuned models, wherein each of the at least one pre-trained based model and the plurality of fined tuned models comprises a plurality of components that correspond to a text encoder, a vision encoder, or a projection layer of the VLM;
determining a first set of weights that correspond to the plurality of components;
generating a first merged model by performing a component-wise merging that comprises:
multiplying the plurality of components with the first set of weights; and
combining the multiplied plurality of components;
determining a first performance of the first merged model by validating the first merged model based on an optimization objective;
determining a second set of weights that correspond to the plurality of components;
generating a second merged model by performing the component-wise merging using the second set of weights; and
determining a second performance of the second merged model by validating the second merged model based on the optimization objective,
wherein, in a first case that the first performance exceeds the second performance, the first electronic device transmits the first merged model to the second electronic device, and
wherein, in a second case that the second performance exceeds the first performance, the first electronic device transmits the second merged model to the second electronic device.

14. The computer-implemented method of claim 13, wherein the optimization objective is determined based on a number of target tasks, a plurality of validation sets for each target set, and task-specific metric calculation functions.

15. The computer-implemented method of claim 14, further comprising:
determining additional sets of weights that correspond to the plurality of components; and
generating additional merged models based on an optimization operation with respect to the optimization objective, until performances of the additional merged models are converged to a target value.

16. The computer-implemented method of claim 15, wherein the optimization operation is Bayesian optimization.

17. The computer-implemented method of claim 13, wherein the first set of weights are initialized before the component-wise merging is performed.

18. The computer-implemented method of claim 13, each of the first performance and the second performance relates to at least one constraint of data costs of a graphic processing unit (GPU) or a budget to operate the improved VLM.
